(19) United States
(12) Patent Application Publication
(10) Pub. No.: US 2007/0220338 A1
(43) Pub. Date: Sep. 20, 2007

(54) Method and system for generating checkpoints of hardware description language simulations that include a specific model state together with a software testcase state

(75) Inventors: Parag Birmiwal, Austin, TX (US); Tilman Gloekler, Gaertringen (DE); Srinivas V.N. Polisetty, Andhra Pradesh (IN); Karl Heinz Uhl, Weil Im Schonbuch (DE)

Correspondence Address: IBM CORPORATION, 3605 HIGHWAY 52 NORTH, DEPT 917, ROCHESTER, MN, 55901-7829, US

(73) Assignee: INTERNATIONAL BUSINESS MACHINES CORPORATION, ARMONK, NY (US)

(21) Appl. No.: 11/351,233

(22) Filed: Feb. 9, 2006

(51) Int. Cl. G06F 11/00

(52) U.S. Cl. 714/33

(57) ABSTRACT

A method for performing verification is disclosed. In response to determining that a log replay module operating in a replay mode has received a command from a testcase that is not equal to a next command in a replay log, a determination is made whether the command is a create relay checkpoint command with a testcase parameter matching a model checkpoint file. In response to determining that the command from the testcase is the create replay checkpoint command with the testcase parameter matching the model checkpoint file, the model checkpoint file is loaded into the simulator, and one or more items of cycle information of the simulator are set to information corresponding to the model checkpoint file.

### BACKGROUND OF THE INVENTION

1. Field of the Invention

The present invention relates in general to verifying designs and in particular to reducing resource requirements during verification. Still more particularly, the present invention relates to a system, method and computer program product for generating checkpoints of hardware description language simulations that include a specific model state together with a software testcase state.

2. Description of the Related Art

With the increasing penetration of microprocessor-based systems into every facet of human activity, demands have increased on the microprocessor development and production community to produce systems that are free from data corruption. Microprocessors have become involved in the performance of a vast array of critical functions, and the involvement of microprocessors in the important tasks of daily life has heightened the expectation of reliability of calculative results. Whether the impact of errors would be measured in human lives or in mere dollars and cents, consumers of microprocessors have lost tolerance for error-prone results. Consumers will not tolerate, by way of example, miscalculations on the floor of the stock exchange, in the medical devices that support human life, or in the computers that control their automobiles. All of these activities represent areas where the need for reliable microprocessor results has risen to a mission-critical concern.

Formal and semiformal verification techniques provide powerful tools for discovering errors in verifying the correctness of logic designs. Formal and semiformal verification techniques frequently expose probabilistically uncommon scenarios that may result in a functional design failure. Frequently, formal and semiformal verification techniques provide the opportunity to prove that a design is correct (i.e., that no failing scenario exists).

Unfortunately, formal verification techniques require computational resources which are exponential with respect to the size of the design under test. In particular, many formal analysis techniques require exponential resources with respect to the number of state elements in the design under test. Semi-formal verification techniques leverage formal methods on larger designs by applying them only in a resource-bounded manner, though at the expense of incomplete verification coverage; generally, coverage decreases as design size increases.

When trying to verify a specific functionality of complex, multimillion-gate chip designs, simulation time can take hours or days per testcase (and millions of simulation cycles). Examples of time-consumptive simulation jobs are POR (Power On Reset) and ABIST simulation runs in pervasive verification. When errors occur during simulation, prior-art methods require that a testcase must be rerun from the beginning to debug an error and create waveform traces. This same testcase must be rerun again after the error is corrected to check the solution to the error. Time consumption in the debug process represents a major bottleneck in the verification process and can hinder further testing of a chip, which interferes with both the verification schedule and ultimate simulation coverage.

While typical hardware description language simulators offer functions to create and restart checkpoint files (i.e., to ascertain the state of the model at a particular point in time), no prior art solution exists to store the status of variables and data structures of the simulation environment that that have been set during the course of the test run. Restarting the simulation of the testcase from the beginning and loading only a simulator checkpoint file created at an nth cycle can lead to a time mismatch and a state mismatch between the testcase and the simulator. The state of the prior art requires modification of testcases to restart from checkpoints, which involves error-prone guesswork about the value of variables and data structures at the time of the checkpoint.

What is needed is a method, system and computer program product for generating checkpoints of hardware description language simulations that include a specific model state together with a software testcase state.

### SUMMARY OF THE INVENTION

A method for performing verification is disclosed. In response to determining that a log replay module operating in a replay mode has received a command from a testcase that is not equal to a next command in a replay log, a determination is made whether the command is a create relay checkpoint command with a testcase parameter matching a model checkpoint file. In response to determining that the command from the testcase is the create replay checkpoint command with the testcase parameter matching the model checkpoint file, the model checkpoint file is loaded into the simulator, and one or more items of cycle information of the simulator are set to information corresponding to the model checkpoint file.

### BRIEF DESCRIPTION OF THE DRAWINGS

The present invention is described in a preferred embodiment in the following description with reference to the drawings, in which like numbers represent the same or similar elements, as follows:

FIG. 1 illustrates a block diagram of a general-purpose data processing system with which the present invention of a method, system and computer program product for generating checkpoints of hardware description language simulations that include a specific model state together with a software testcase state may be performed; and

FIGS. 2A-B show a high-level logical flowchart of a process for performing verification while generating checkpoints of hardware description language simulations that include a specific model state together with a software testcase state.

### DETAILED DESCRIPTION OF A PREFERRED EMBODIMENT

The present invention provides method, system and computer program product for generating checkpoints of hardware description language simulations that include the specific model state together with a software testcase state. The present invention mimics simulation until a user-defined point in a testcase by using a ‘test replay’ feature. Once the chosen point is reached, the testcase switches from replay mode back to ‘live simulation’ mode by loading a checkpoint file and continuing with simulation.

The present invention relies upon a software module called a “Log Replay Module” (LRM), which is instantiated at the start of a testcase and resides in the communication path between a testcase and a simulator. The first time that a testcase is run, the LRM creates a replay log, in which all interactions between the testcase and simulator are logged. The second time that a testcase is run, in response to a bug discovery, the LRM does not pass commands from the testcase to the simulator, but simply replays the simulator's answer to each command from the log file until the desired simulation time of a desired checkpoint is reached. Afterwards, the simulator loads the stored checkpoint, and the testcase continues in a regular mode by passing commands to the simulator until the end of the testcase is reached.

Because the testcase is then run in an unmodified form, all variables, memory models, etc. are initialized to expected values. Using the present invention, the simulator is unaware that no simulation was run in replay mode because the simulator receives responses identical to those created when the replay log was created. No modifications to the testcase are required, and millions of cycles of simulation time can be saved.

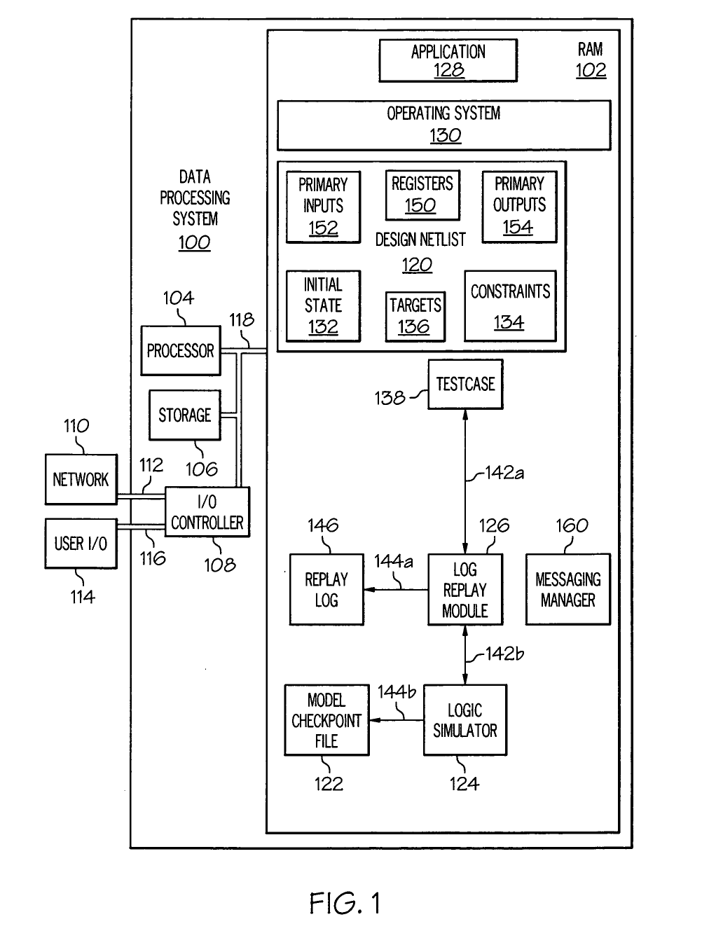

With reference now to the figures, and in particular with reference to FIG. 1, a block diagram of a general-purpose data processing system, in accordance with a preferred embodiment of the present invention, is depicted. Data processing system 100 contains a processing storage unit (e.g., RAM 102) and a processor 104. Data processing system 100 also includes non-volatile storage 106 such as a hard disk drive or other direct-access storage device. An Input/Output (I/O) controller 108 provides connectivity to a network 110 through a wired or wireless link, such as a network cable 112. I/O controller 108 also connects to user I/O devices 114 such as a keyboard, a display device, a mouse, or a printer through wired or wireless link 116, such as cables or a radio-frequency connection. System interconnect 118 connects processor 104, RAM 102, storage 106, and I/O controller 108.

Within RAM 102, data processing system 100 stores several items of data and instructions while operating in accordance with a preferred embodiment of the present invention, including a design netlist 120 and an model checkpoint file 122 for interaction with a logic simulator 124. Other applications 128 and logic simulator 124 interface with processor 104, RAM 102, I/O control 108, and storage 106 through operating system 130. Other data structures in RAM 102 include a messaging center 160 for creating socket connections 142a-142b and data dumps 144a-144b. A testcase 138 provides stimuli that are applied to logic simulator 124. A log replay module 126 for interaction with a replay log 146 is also included. One skilled in the data processing arts will quickly realize that additional components of data processing system 100 may be added to or substituted for those shown without departing from the scope of the present invention.

A netlist graph, such as design netlist 120, is a popular means of compactly representing circuit structures in computer-aided design of digital circuits. Such a representation is non-canonical and offers limited ability to analyze the function from the nodes in the graph. Design netlist 120 contains a directed graph with vertices representing gates and edges representing interconnections between those gates. The gates have associated functions, such as constraints 134, targets 136, primary inputs 152, primary outputs 154, combinational logic (e.g., AND gates), and sequential elements (hereafter referred to as registers 150). Registers 150 have two associated components: their next-state functions and their initial-value functions, which are represented as other gates in the graph or as an initial state data structure 132. Semantically, for a given register 150, the value appearing at its initial-value gate at time “0” (“initialization” or “reset” time) will be applied as the value of the register itself; the value appearing at its next-state function gate at time “i” will be applied to the register itself at time “i+1”.

Processor 104 executes instructions from programs, often stored in RAM 102, in the course of performing the present invention. In a preferred embodiment of the present invention, processor 104 executes logic simulator 124. Logic simulator 124 performs testing operations on design netlist 120. Logic simulator 124 includes a computer program product, stored in RAM 102 and executed on processor 104, which provides a series of tools for activities such as equivalence checking, property checking, logic synthesis and false-paths analysis. Generally speaking, logic simulator 124 contains rule-based instructions for predicting the behavior of logically modeled items of hardware.

Targets 136 represent nodes whose Boolean expressions are of interest and need to be computed. The goal of the verification process is to find a way to drive a ‘1’ on a target 136 node, or to prove that no such assertion of the target 136 is possible. In the former case, a “counterexample trace” showing the sequence of assignments to the inputs in every cycle leading up to the failure event is generated and recorded to model checkpoint file 122.

Logic simulator 124 uses the series of rules contained in its own instructions, in conjunction with design netlist 120, to represent the underlying logical problem structurally (as a circuit graph), and includes a Cycle-Based Symbolic Simulator (CBSS), which performs a cycle-by-cycle simulation on design netlist 120 symbolically by applying unique random, or non-deterministic, variables to the design netlist 120 inputs 152 in every cycle.

At each step of the simulation, the Boolean expressions of the target 136 nodes are tested for assertion of a value of ‘1’. If so, a counterexample trace leading up to the failure (represented by the assertion of the target 136 node to a ‘1’) is generated. Constraints 134 are factored in before this check for the targets 136 being hit is performed. This factoring is typically accomplished by simply ANDing the Boolean expression for the target 136 with the Boolean expression for each of the constraints 134.

If unsolved targets 136 remain, then the registers 150 are updated with the values of the next-state functions, and the process continues.

With the present invention, Log Replay Module (LRM) 126 is instantiated at the start of testcase 138 by the testcase itself 138 and resides in the communication path between testcase 138 and logic simulator 124. The position of LRM 126 in the communication path between testcase 138 and logic simulator 124 is the result of several steps. First, before beginning operation with testcase 138, testcase 138 invokes LRM 126 (as a child process) and creates a first socket connection 142a between LRM 126 and testcase 138. LRM 126 creates a second socket connection 142b between LRM 126 and logic simulator 124.

The first time that a testcase is run, the LRM 126 creates replay log 146, in which all interactions between the testcase 138 and logic simulator 124 are logged through data dumps 144a. Replay log 146 contains cycle time information which corresponds with cycle time information for testcase 138 and for the model status data in model checkpoint file 122. A replay log 146 is created each time that testcase 138 is run. Each command sent to logic simulator 124 is logged with the response of logic simulator 124. A user can create checkpoints in both model checkpoint file 122 and replay log 146 by introducing a command ‘create_replay_checkpoint’ into testcase 138. The checkpoint for the replay log consists of the sequence of commands from testcase 138 and replies from logic simulator 124 in the replay log 146. The ‘create_replay_checkpoint’ command can be modified to optionally overwrite previous checkpoints to save disk space or can be used for switching from replay mode to real mode in the rerun of testcase 138.

The second (or subsequent) time that testcase 138 is run, for example, in response to a bug discovery, LRM 126 does not pass commands from testcase 138 to logic simulator 124, but instead replays from replay log 146 the answer from logic simulator 124 to each command from testcase 138 until the command ‘create_replay_checkpoint’ matches a specific cycle time information of the desired model checkpoint file 122. Afterward, logic simulator 124 loads the stored checkpoint in model checkpoint file 122, and testcase 138 continues in a regular simulation mode by passing commands to logic simulator 124 through first socket connection 142a, LRM 126 and second socket connection 142b until the end of testcase 138 is reached.

LRM 126 operates in two different modes, replay mode and real (log) mode. The default mode of LRM 126 is real (log) mode. If testcase 138 is started with a testcase parameter containing information about the replay checkpoint file 122 to use, LRM 126 switches from real mode to replay mode.

LRM 126 performs the following operations in a loop until testcase 138 closes first socket connection 142a to logic simulator 124. In Real (log) mode, LRM 126 waits for a command to arrive across first socket connection 142a from testcase 138. LRM 126 then evaluates the command. If the command is a normal command from testcase 138, LRM 126 passes the command to logic simulator 124 over second socket connection 142b and logs it into replay log 146 through data dump 144a. LRM 126 then waits for an answer to arrive across second socket connection 142b from logic simulator 124. LRM 126 then passes the received answer to testcase 138 across first socket connection 142a and logs the answer within replay log 146 through data dump 144a. If the command that arrives from testcase 138 across first socket connection 142a is a ‘create_replay_checkpoint’ command to create a new model checkpoint in model checkpoint file 122, LRM 126 logs to replay log 146 through data dump 144a information about model checkpoint file 122 and the cycle time of logic simulator 124. LRM 126 then passes the command to logic simulator 124 across second socket connection 142b to create or update model checkpoint file 122 through data dump 144b.

In replay mode, LRM 126 waits for a command to arrive across first socket connection 142a from testcase 138. When a command arrives via first socket connection 142a from testcase 138, LRM 126 compares the command received via first socket connection 142a from testcase 138 with the next command from replay log 146. If the command received across first socket connection 142a from testcase 138 and the next command from replay log 146 are equal, then LRM 126 continues in replay mode and evaluates the command received across first socket connection 142a from testcase 138. If the command received across first socket connection 142a from testcase 138 and the next command from replay log 146 are not equal, LRM 126 stops replaying, as replaying would lead to consistency problems. If the command received across first socket connection 142a from testcase 138 is a command to modify a state of logic simulator 124, (e.g., the “broadside” command), then LRM 126 passes the command received across first socket connection 142a from testcase 138 to logic simulator 124 across second socket connection 142b, waits for an answer to be received from logic simulator 124 across second socket connection 142b, and, when an answer is received from logic simulator 124 across second socket connection 142b, compares the received answer to the expected answer logged in the replay log 146. If the two answers are equal, LRM 126 sends the answer back across first socket connection 142a to testcase 138. If the two answers are not equal, LRM 126 stops replay mode in a manner similar to that used when commands do not match.

In replay mode, if the command received across first socket connection 142a from testcase 138 is a usual testcase command (e.g., stick, putfac, assigning values to signals or clocking the simulator), LRM 126 will not pass the command received across first socket connection 142a from testcase 138 to logic simulator 124. Instead, LRM 126 retrieves an answer associated to this command from the replay log 146 and sends the answer back to the testcase 138 across first socket connection 142a. If the command received across first socket connection 142a from testcase 138 is the ‘create_replay_checkpoint’ command and the parameter given in the testcase 138 matches information about model checkpoint file 122, then LRM 126 loads model checkpoint file 122 into logic simulator 124, sets cycle information in logic simulator 124 to the information associated with the model checkpoint file 122 and switches from replay mode to real mode to continue with real simulation. If the parameter does not match the information about model checkpoint file 122, LRM 126 blocks the command, passes an answer from replay log 146 to testcase 138, and continues in the replay mode.

In one embodiment, replay log 146 is a file containing pairs of lines, which represent the communication between testcase 138 and logic simulator 124. Each pair consists of a command line and an answer line. Replay log 146 is created by LRM 126 during log mode when testcase 138 is run. LRM 126 uses replay log 146 during replay mode to compare commands received from testcase 138 and to simulate an answer provided by logic simulator 124. An example of the content of replay log 146 follows:

...
broadside
0>
...
putfac N0.BRD0.A.B.C.L2(0:15) 0100110011010101 B
0>0100110011010101
...
getfac N0.BRD0.X.Y.Z.L2(0:4)
0>8
...
stick N0.BRD0.G.H.I.J.L2(0) 1 B
0>1
...

The commands in testcase 138 can be split into two different groups. The first group contains commands that change the state of the model from design netlist 120 in logic simulator 124. Some examples are “stick”, “putfac”, “clock”, or “getfac”. The second group contains commands that change the state of logic simulator 124. Examples are “broadside” and “set_JTAG_speed”. LRM 126 passes all commands from the second group to logic simulator 124 across second socket connection 142b in both replay mode and real mode.

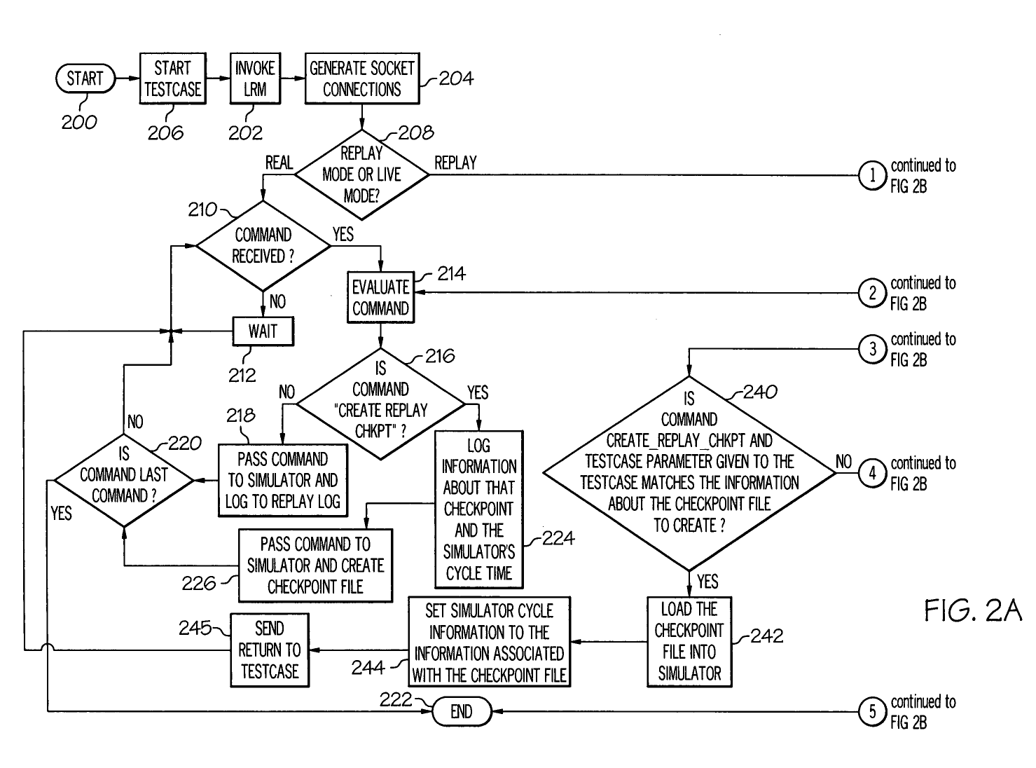

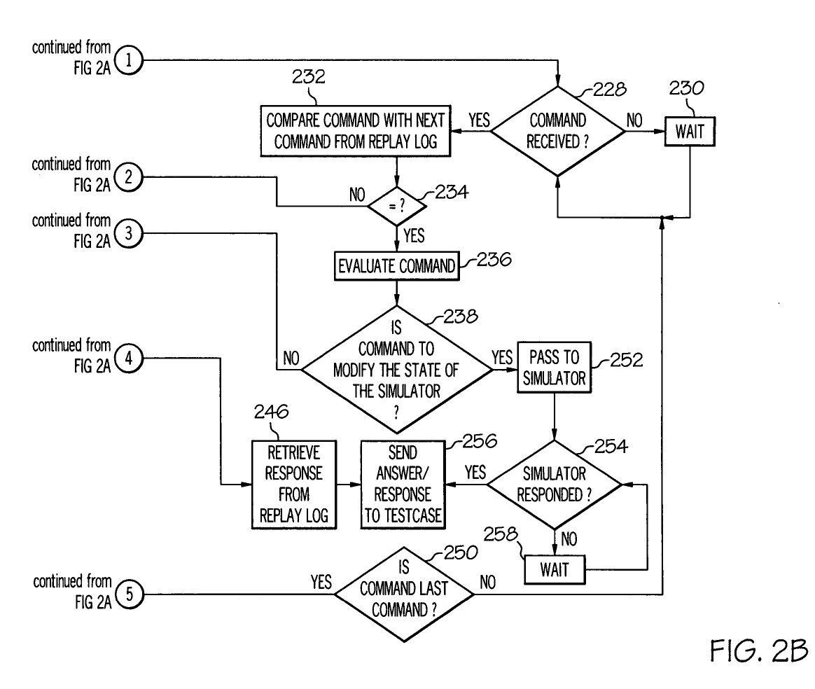

Turning now to FIGS. 2A-B, a high-level flowchart of a process for generating checkpoints of hardware description language simulations that include a specific model state together with a software testcase state is disclosed. The process starts at step 200 and then moves to step 206, which illustrates logic simulator 124 starting testcase 138. The process then moves to step 202, which illustrates the testcase 138 invoking LRM 126. At step 204, LRM 126 generates first socket connection 142a and second socket connection 142b. The process next moves to step 208.

At step 208, LRM 126 determines whether LRM 126 is in replay mode or real mode, a determination that will usually be made on the basis of user input. If LRM 126 is in real mode, then the process proceeds to step 210, which depicts LRM 126 determining whether LRM 126 has received a command from testcase 138 across first socket connection 142a. If LRM 126 determines that LRM 126 has not received a command from testcase 138 across first socket connection 142a, then the process proceeds to step 212, in which LRM 126 waits. The process then returns to step 210. If LRM 126 determines that LRM 126 has received a command from testcase 138 across first socket connection 142a, then the process moves to step 214. At step 214, LRM 126 evaluates the command received from testcase 138 across first socket connection 142a.

The process next moves to step 216, which depicts LRM 126 determining whether the command received from testcase 138 across first socket connection 142a is a ‘create_replay_checkpoint’ command. If not, the process next passes to step 218. Step 218 depicts LRM 126 passing the command received from testcase 138 across first socket connection 142a to logic simulator 124a across second socket connection 142b and logging the command within replay log 146 using data dump 144a. The process then moves to step 220. Step 220 illustrates LRM 126 determining if the command received from testcase 138 across first socket connection 142a is the last command of testcase 138. If so, then the process ends at step 222. If LRM 126 determines that the command from testcase 138 received across first socket connection 142a is not the last command of testcase 138, then the process returns to step 210.

Returning to step 216, if LRM 126 determines that the command received from testcase 138 across first socket connection 142a is a ‘create_replay_checkpoint’ command, then the process proceeds to step 224, which depicts LRM 126 logging information about the checkpoint and the cycle time of logic simulator 124 to replay log 146. The process then proceeds to step 226. Step 226 illustrates LRM 126 passing the command received from testcase 138 across first socket connection 142a to logic simulator 124 across second socket connection 142b, with the result that logic simulator 124 creates model checkpoint file 122 using data dump 144b. The process then returns to step 220.

Returning to step 208, if LRM 126 is in replay mode, then the process proceeds to step 228, which illustrates LRM 126 determining if a command has been received from testcase 138 across first socket connection 142a. If LRM 126 determines that no command has been received from testcase 138 across first socket connection 142a, then the process proceeds to step 230, during which LRM 126 waits. The process then returns to step 228. If LRM 126 receives a command from testcase 138 across first socket connection 142a, then the process proceeds to step 232. At step 232, LRM 126 compares the command received from testcase 138 across first socket connection 142a with a next command from replay log 146. The process then proceeds to step 234.

At step 234, LRM 126 determines whether the command received from testcase 138 across first socket connection 142a is equivalent to a next command from replay log 146. If not, the process returns to step 214 (and returns to real mode). If LRM 126 determines that the command received from testcase 138 across first socket connection 142a is equivalent to a next command from replay log 146, then the process next moves to step 236. Step 236 depicts LRM 126 evaluating the command received from testcase 138 across first socket connection 142a. The process then moves to step 238.

Step 238 illustrates LRM 126 determining whether the command received from testcase 138 across first socket connection 142a is a command to modify a state of logic simulator 124. If not, then the process next moves to step 240, which illustrates LRM 126 determining whether the command received from testcase 138 across first socket connection 142a is the ‘create_replay_checkpoint’ command with a testcase parameter matching a model checkpoint file 122 to be created. If so, then the process proceeds to step 242. At step 242, LRM 126 loads model checkpoint file 122 into logic simulator 124. The process then moves to step 244, which depicts LRM 126 setting cycle information in logic simulator 124 to information associated with model checkpoint file 122. The process then proceeds to step 245. At step 245 LRM 126 sends a return to testcase 138 across first socket connection 142a.

Returning to step 240, if LRM 126 determines that the command received from testcase 138 across first socket connection 142a is not a ‘create_replay_checkpoint’ command with a testcase parameter that matches information about a model checkpoint file 122, then the process proceeds to step 246. Step 246 portrays LRM 126 retrieving a response from replay log 146. The process then moves to step 256. At step 256, LRM 126 sends the response from replay log to testcase 138 across first socket connection 142a. The process then moves to step 250, which illustrates LRM 126 determining whether the command received from testcase 138 across first socket connection 142a is the last command of testcase 138. If LRM 126 determines that the command received from testcase 138 across first socket connection 142a is the last command of testcase 138, then the process ends at step 222. If LRM 126 determines that the command received from testcase 138 across first socket connection 142a is not the last command of testcase 138, then the process returns to step 228, which is described above.

Returning to step 238, if LRM 126 determines that the command received from testcase 138 across first socket connection 142a is a command to modify a state of logic simulator 124, then the process proceeds to step 252, which illustrates LRM 126 passing the command received from testcase 138 across first socket connection 142a to logic simulator 124 across second socket connection 142b. The process then moves to step 254. Step 254 depicts LRM 126 determining whether logic simulator 124 has responded across second socket connection 142b. If LRM 126 determines that logic simulator 124 has responded across second socket connection 142b, then the process returns to step 256, which is described above. If LRM 126 determines that logic simulator 124 has not responded across second socket connection 142b, then the process proceeds to step 258, at which LRM 126 waits, and then returns to step 254.

While the invention has been particularly shown as described with reference to a preferred embodiment, it will be understood by those skilled in the art that various changes in form and detail may be made therein without departing from the spirit and scope of the invention. It is also important to note that although the present invention has been described in the context of a fully functional computer system, those skilled in the art will appreciate that the mechanisms of the present invention are capable of being distributed as a program product in a variety of forms, and that the present invention applies equally regardless of the particular type of signal bearing media utilized to actually carry out the distribution. Examples of signal bearing media include, without limitation, recordable type media such as floppy disks or CD ROMs and transmission type media such as analog or digital communication links.

What is claimed is:

1. A method in data processing system, said method comprising:
in response to determining that a log replay module operating in a replay mode has received a command from a testcase that is not equal to a next command in a replay log, determining whether said command is a create relay checkpoint command with a testcase parameter matching a model checkpoint file;
in response to determining that said command from said testcase is said create replay checkpoint command with said testcase parameter matching said model checkpoint file, loading said model checkpoint file into said simulator; and
setting one or more items of cycle information of said simulator to information corresponding to said model checkpoint file.

2. The method of claim 1, further comprising,
in response to determining that said command from said testcase is not said create replay checkpoint command with said testcase parameter matching said model checkpoint file, retrieving a response from a replay log.

3. The method of claim 1, further comprising, in response to determining that a log replay module operating in a live mode has received a command from a testcase that is a command to create a replay checkpoint,
logging one or more items of information related to said replay checkpoint and said simulator's cycle time to a replay log; and
passing a command to create said model checkpoint file to said simulator.

4. The method of claim 1, further comprising, in response to determining that a log replay module operating in a live mode has received a command from a testcase that is not a command to create a replay checkpoint, passing said command to said simulator across a socket connection and passing said command to a replay log using a data dump.

5. The method of claim 1, further comprising, in response to determining that said log replay module operating in said replay mode has received a command from a testcase that is a command to modify a state of said simulator, wherein said command from said testcase is not equal to a next command in a replay log,
passing said command to said simulator;
determining whether said simulator has responded; and
in response to determining that said simulator has responded, sending a return to said testcase.

6. The method of claim 1, further comprising, in response to determining that said log replay module operating in said replay mode has received a command from a testcase that is not equal to said next command from said log replay module, entering a live mode.

7. The method of claim 1, further comprising
evaluating said command;
determining whether said command is a last command;
receiving said command across a socket connection;
invoking said log replay module;
generating said socket connection;
sending a return to said testcase;
starting said testcase; and
comparing said command with said next command from said replay log.

8. A system for verification by a data processing system, said system comprising:
means for, in response to determining that a log replay module operating in a replay mode has received a command from a testcase that is not equal to a next command in a replay log, determining whether said command is a create relay checkpoint command with a testcase parameter matching a model checkpoint file;
means for, in response to determining that said command from said testcase is said create replay checkpoint command with said testcase parameter matching said model checkpoint file, loading said model checkpoint file into said simulator; and
means for setting one or more items of cycle information of said simulator to information corresponding to said model checkpoint file.

9. The system of claim 8, further comprising,
means for, in response to determining that said command from said testcase is not said create replay checkpoint command with said testcase parameter matching said model checkpoint file, retrieving a response from a replay log.

10. The system of claim 8, further comprising, means for, in response to determining that a log replay module operating in a live mode has received a command from a testcase that is a command to create a replay checkpoint,
logging one or more items of information related to said replay checkpoint and said simulator's cycle time to a replay log; and
passing a command to create said model checkpoint file to said simulator.

11. The system of claim 8, further comprising, means for, in response to determining that a log replay module operating in a live mode has received a command from a testcase that is not a command to create a replay checkpoint, passing said command to said simulator across a socket connection and passing said command to a replay log using a data dump.

12. The system of claim 8, further comprising, means for, in response to determining that said log replay module operating in said replay mode has received a command from a testcase that is a command to modify a state of said simulator, wherein said command from said testcase is not equal to a next command in a replay log,
passing said command to said simulator;
determining whether said simulator has responded; and
in response to determining that said simulator has responded, sending a return to said testcase.

13. The system of claim 8, further comprising, means for, in response to determining that said log replay module operating in said replay mode has received a command from a testcase that is not equal to said next command from said log replay module, entering a live mode.

14. The system of claim 8, further comprising
means for evaluating said command;
means for determining whether said command is a last command;
means for receiving said command across a socket connection;
means for invoking said log replay module;
means for generating said socket connection;
means for sending a return to said testcase;
means for starting said testcase; and
means for comparing said command with said next command from said replay log.

15. A machine-readable medium having a plurality of instructions processable by a machine embodied therein, wherein said plurality of instructions, when processed by said machine, causes said machine to perform a method comprising:
in response to determining that a log replay module operating in a replay mode has received a command from a testcase that is not equal to a next command in a replay log, determining whether said command is a create relay checkpoint command with a testcase parameter matching a model checkpoint file;
in response to determining that said command from said testcase is said create replay checkpoint command with said testcase parameter matching said model checkpoint file, loading said model checkpoint file into said simulator; and
setting one or more items of cycle information of said simulator to information corresponding to said model checkpoint file.

16. The computer-readable medium of claim 15, said method further comprising,
in response to determining that said command from said testcase is not said create replay checkpoint command with said testcase parameter matching said model checkpoint file, retrieving a response from a replay log.

17. The computer-readable medium of claim 15, said method further comprising, in response to determining that a log replay module operating in a live mode has received a command from a testcase that is a command to create a replay checkpoint,
logging one or more items of information related to said replay checkpoint and said simulator's cycle time to a replay log; and
passing a command to create said model checkpoint file to said simulator.

18. The computer-readable medium of claim 15, said method further comprising, in response to determining that a log replay module operating in a live mode has received a command from a testcase that is not a command to create a replay checkpoint, passing said command to said simulator across a socket connection and passing said command to a replay log using a data dump.

19. The computer-readable medium of claim 15, said method further comprising, in response to determining that said log replay module operating in said replay mode has received a command from a testcase that is a command to modify a state of said simulator, wherein said command from said testcase is not equal to a next command in a replay log,
passing said command to said simulator;
determining whether said simulator has responded; and
in response to determining that said simulator has responded, sending a return to said testcase.

20. The computer-readable medium of claim 15, said method further comprising, in response to determining that said log replay module operating in said replay mode has received a command from a testcase that is not equal to said next command from said log replay module, entering a live mode.
